(19) United States
(12) Patent Application Publication
(10) Pub. No.: US 2003/0039368 A1
(43) Pub. Date: Feb. 27, 2003

(54) Optical microphone noise suppression system

(75) Inventors: Alexander Paritsky, Modiin (IL); Sergei Smirnov, Yehud (IL); Avraham Kushnirov, Yishuv Barkan (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Phone-Or Ltd., Or-Yehuda (IL)

(21) Appl. No.: 10/226,707

(22) Filed: Aug. 22, 2002

(30) Foreign Application Priority Data
Aug. 24, 2001 (IL) 145110

(51) Int. Cl. H04R 29/00; H04R 3/00

(52) U.S. Cl. 381/58; 381/111

(57) ABSTRACT

A dynamic noise suppression system for an optical microphone including an optical microphone having a light source illuminating an acoustically sensitive membrane reflecting light onto a photodetector and an input and an output, a logarithmic amplifier connected to the output of the optical microphone, a variable impedance connected between the output of the amplifier and the input to the optical microphone, the variable impedance receiving control signals from the output of the amplifier, the output of the optical microphone, or an external source.

### FIELD OF THE INVENTION

The present invention relates to optical microphones, and in particular to a noise suppression system for an optical microphone.

### BACKGROUND OF THE INVENTION

Optical microphone noise suppression systems are used to suppress background noises and to increase sound-to-noise ratio. Such systems change their sensitivity when background noise rises, and thus diminish noise signal levels in communication systems. The drawback of such systems is that the ratio between the background noise level and the gradient of the sensitivity change is constant. Furthermore, a person's speech may be perceived by such a system as noise, thereby changing its sensitivity although there is no background noise.

### DISCLOSURE OF THE INVENTION

It is therefore a broad object of the present invention to provide a dynamic noise suppression system for optical microphones. It is a further object of the invention to provide an optical microphone noise suppression system that changes its sensitivity substantially only when background noise exists.

The invention therefore provides a noise suppression system for an optical microphone having an input and an output, said system comprising a logarithmic amplifier connectable to the output of said optical microphone, and a variable impedance connected between said logarithmic amplifier and the input to said optical microphone, said variable impedance being connected to receive control signals from the output of said logarithmic amplifier, the output of said optical microphone, or an external source.

The invention further provides an optical microphone dynamic noise suppression system, comprising an optical microphone, constituted by a source of light connectable to a power source, a membrane responsive to acoustic energy inpinging thereon, and a photodetector for detecting light emitted by said source of light and reflected by said membrane; a logarithmic amplifier connectable to the output of said optical microphone, and a variable impedance connected between said logarithmic amplifier and said source of light, said variable impedance being connected to receive control signals from the output of said logarithmic amplifier, the output of said optical microphone, or an external source.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a circuit diagram of a prior art optical microphone noise suppression system;

FIG. 2 is a circuit diagram of an optical microphone noise suppression system according to the present invention;

FIG. 3 is a voltage diagram of the circuit of FIG. 2;

FIG. 4 is a circuit diagram of a system according to the present invention having an internal noise signal source, and

FIG. 5 is a circuit diagram of a system according to the present invention having an external noise signal source.

### DETAILED DESCRIPTION

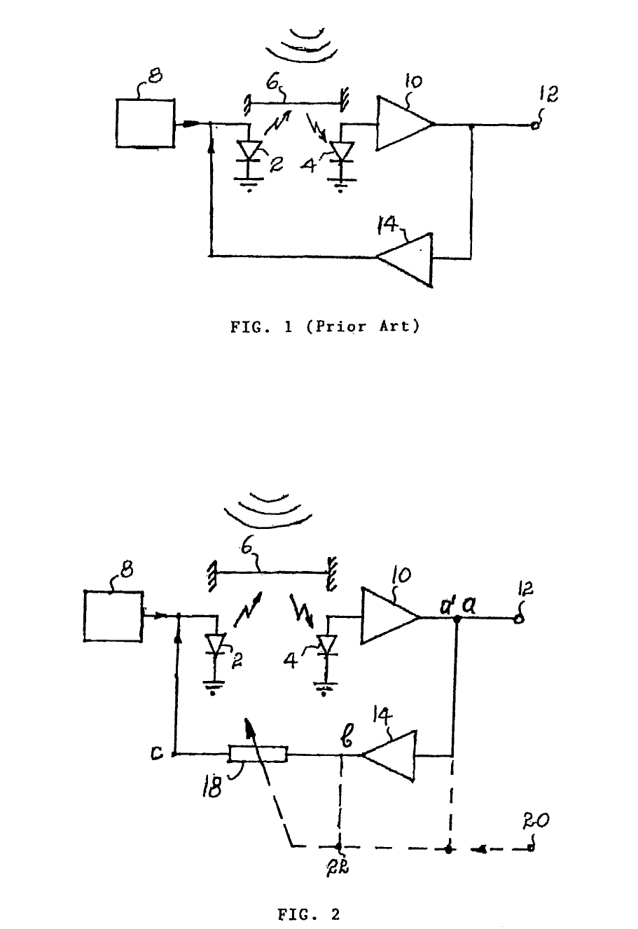

The prior art system optical microphone noise suppression system illustrated in FIG. 1 consists of a source of light 2, a photodetector 4, an acoustically sensitive reflective membrane 6 responsive to an incoming acoustical signal, and a source of current 8 supplying current to the source of light 2. The output of the photodetector 4 is fed to a signal amplifier 10 and therethrough to the system's output 12. A logarithmic amplifier 14 is connected between the output of amplifier 10 and the line connecting between the source of current 8 and the input to the source of light 2.

Light from source of light 2 illuminates acoustically sensitive membrane 6, which reflects the light onto photodetector 4. Amplifier 10 amplifies the signals from photodetector 4 and feeds the signals to output 12 and to logarithmic amplifier 14. The output from logarithmic amplifier 14 is fed to the source of light 2, either in or out of a phase of the signals from photodetector 4.

FIG. 2 depicts an embodiment of the present invention, in which the suppression of noise is effected substantially only with respect to background noise and not with respect to the desired acoustical signals. In order to achieve same, the system is provided with a variable impedance 18, e.g., a resistor, a transistor, or the like, responsive to and operable by an external signal applied at 20 for controlling the attenuation of the signals passing between the output of amplifier 14 and the input of source of light 2.

The resistance value of variable impedance 18 may be changed by internal signals applied at point 22, which may be output signals of amplifier 14 or output signals from amplifier 10. In quiet conditions, when there is no acoustical noise, the resistance is very high and very low signals from the output of amplifier 14 are fed to the source of light 2. In such a case, there is no noise suppression at all. If the average signals at the output of amplifiers 10 or 14 increase, the value of impedance 18 is decreased. Increasing values of output signals from amplifier 14 are fed to the input of source of light 2; hence, noise suppression is decreased.

FIG. 3 is a voltage diagram of the operation of the system of FIG. 2, wherein a¹ represents the output signals from amplifier 10 without a connection between the output of amplifier 14 and the input to source of light 2; b represents a non-conditioned voltage output from logarithmic amplifier 14; c is a conditioned output from logarithmic amplifier 14, and a is the output from an amplifier 14 when the output from amplifier 14 is connected to the input of source of light 2.

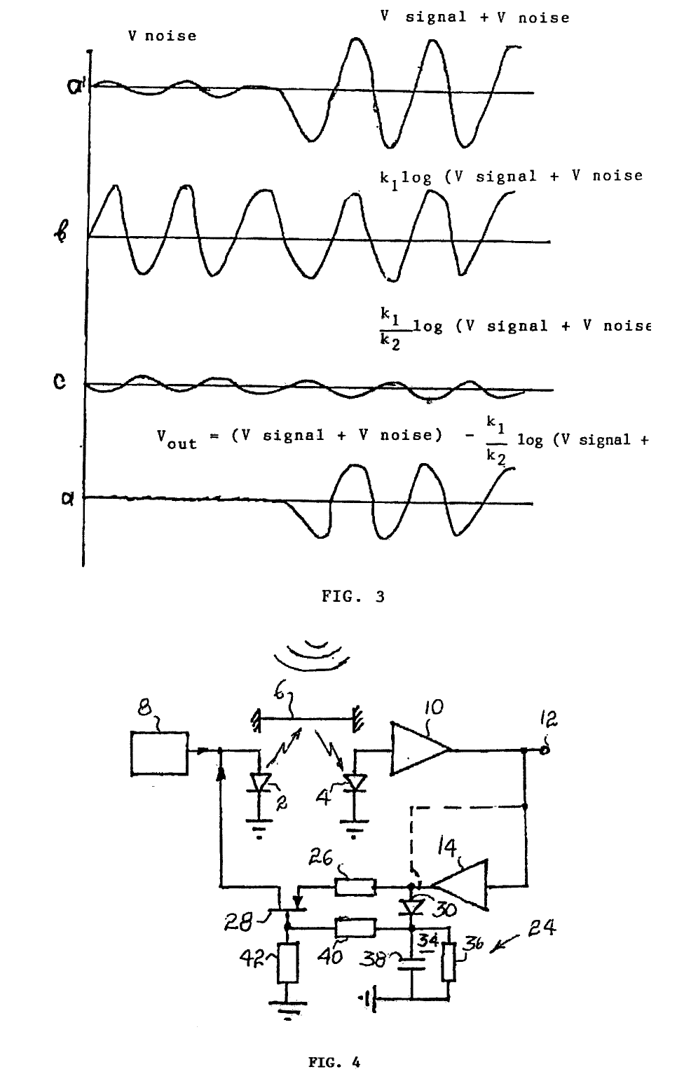

FIG. 4 illustrates another embodiment of the invention, in which the noise suppression is achieved by an internally operating circuit 24. Circuit 24 consists of a conditional resistor 26 connected at the output of amplifier 14 and an impedance in the form of a field effect transistor 28, which is connected to the input of the source of light 2. A rectifier diode 30 leads from the output of amplifier 14 to a low frequency filter 34 consisting of a resistor 36 and capacitor 38. 40, 42 are conditioning resistors. The rectifing diode 30 may be connected with the output of amplifier 10 instead of the output of amplifier 14, as shown by the broken line.

When the noise at the input to the microphone increases, output signals from amplifier 14 (or amplifier 10) increase, and after rectification by diode 30 and low filtering through filter 34, the signals pass through resistors 40, 42, causing the conduction of field effect transistor 28. As a result, a connection between output signals from amplifier 14 and the input of the source of light 2 is established, signals from amplifier 14 arrive at the input of the source of light 2, and the suppression of noise becomes more prominent.

The low frequency filter 34 is constant, so that speech signals, which are pulsing signals with large intervals between pulses, are filtered and produce almost no voltage to change the condition of field effect transistor 28.

Noise signals are regular, constant signals, without any large changes in their average value. These signals produce constant voltage at low frequency filter 34. The voltage produced causes field effect transistor 28 to conduct, thereby its resistance will decrease and consequently, more current will flow between amplifier 14 and the source of light 2.

During very long or very intensive speech, filter 34 will produce a constant voltage as for noise signals, causing transistor 28 to open and effectively connect amplifier 14 with the source of light 2.

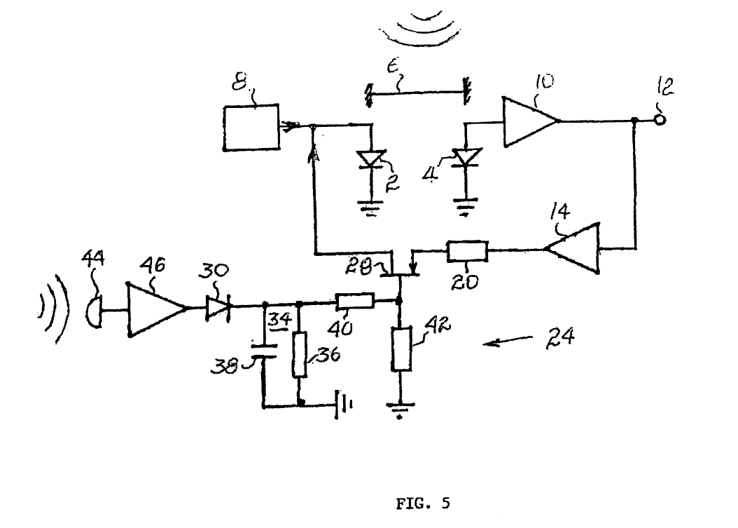

FIG. 5 illustrates another embodiment of the invention for dynamic change of noise suppression, which is especially suitable for work in adverse conditions with heavy background noise, such as noise from a helicopter, tank, racing car, and the like. A circuit 24, comprised of the same components illustrated in FIG. 4, but arranged in a slightly different manner, is connected between conditioning resistor 26 and the source of light 2. The circuit includes an external microphone 44, located farther away from the speaker's mouth and an amplifier 46.

In this case, the resistance of transistor 28 is controlled by external microphone 44, which is placed far from the speaker's mouth. Thus, microphone 44 does not, or nearly does not, receive and respond to the speaker's voice, but does, however, receive and respond to the background noise. Thus, only outside, background noises will change the state of transistor 28, thereby enhancing the noise suppression of signals propagating in the line between the logarithmic amplifier 14 and the source of light 2.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A noise suppression system for an optical microphone having an input and an output, said system comprising:
a logarithmic amplifier connectable to the output of said optical microphone, and
a variable impedance connected between said logarithmic amplifier and the input to said optical microphone, said variable impedance being connected to receive control signals from the output of said logarithmic amplifier, the output of said optical microphone, or an external source.

2. The system as claimed in claim 1, Other comprising:
a second amplifier connectable to the output of said optical microphone and said logarithmic amplifier, said logarithmic amplifier being connected to the output of said second amplifier.

3. The system as claimed in claim 1, wherein said variable impedance is constituted by a variable resistor.

4. The system as claimed in claim 1, wherein said variable impedance is constituted by a transistor, the gate of said transistor being connected through a rectifier and a low pass filter to the output of said logarithmic amplifier.

5. The system as claimed in claim 2, wherein said variable impedance is constituted by a transistor, the gate of said transistor being connected through a rectifier and a low pass filter to the output of said second amplifier.

6. The system as claimed in claim 1, wherein said variable impedance is constituted by a transistor, the gate of said transistor being connected through a low pass filter and a rectifier to a second microphone for receiving outside noise and being located in spaced-apart relationship to said optical microphone, far away from a speaker's mouth.

7. The system as claimed in claim 6, further comprising a third amplifier connected between said second microphone and said rectifier.

8. An optical microphone dynamic noise suppression system comprising
an optical microphone, constituted by a source of light connectable to a power source, a membrane responsive to acoustic energy inpinging thereon, and a photodetector for detecting light emitted by said source of light and reflected by said membrane;
a logarithmic amplifier connectable to the output of said optical microphone, and
a variable impedance connected between said logarithmic amplifier and said source of light, said variable impedance being connected to receive control signals from the output of said logarithmic amplifier, the output of said optical microphone, or an external source.

9. A noise suppression system for an optical microphone as claimed in claim 1, substantially as hereinbefore described and with reference to the accompanying drawings.

10. An optical microphone dynamic noise suppression system as claimed in claim 8, substantially as hereinbefore described and with reference to the accompanying drawings.
